(19) United States
(12) Patent Application Publication
(10) Pub. No.: US 2002/0086636 A1
(43) Pub. Date: Jul. 4, 2002

(54) Method and apparatus for using a standard telephone with a wireless communications system

(75) Inventors: Michael J. Tracy, Scottsbluff, NE (US); Robert L. Hinze, Gering, NE (US)

Correspondence Address: SHERIDAN ROSS PC, 1560 BROADWAY, SUITE 1200, DENVER, CO, 80202

(73) Assignee: Tracy Corporation II

(21) Appl. No.: 10/022,120

(22) Filed: Dec. 13, 2001

Related U.S. Application Data
(63) Continuation of application No. 09/557,667, filed on Apr. 25, 2000.

(51) Int. Cl. H04H 1/00

(52) U.S. Cl. 455/3.01; 455/74.1; 455/564

(57) ABSTRACT

The present invention provides a method and apparatus for placing and receiving telephone calls via a wireless communications network using a standard telephone and, therefore, is referred to as a wireless local loop system that uses a standard telephone. More specifically, in one embodiment, the “*” key is advantageously used to generate a send signal, while the “#” key is advantageously used to generate an end signal. Accordingly, automatic generation of false send signals may be eliminated, while the need of purchasing a specialized telephone handset having a send key and end key thereon may be avoided. Furthermore, in one embodiment, when placing a call, a recorded message (instead of a dial tone) is advantageously played to a user when a telephone is taken “off-hook” so that a user may be notified that the call will be transmitted via a wireless network and, therefore, may be subject to a different pricing structure. In addition, upon receipt of an incoming call, a similar recorded message may be played to a user for like purposes.

### FIELD OF THE INVENTION

The present invention is directed to wireless communication systems, and more particularly, to wireless local loop systems.

### BACKGROUND OF THE INVENTION

Present day wireless telephones include specialized keypads which are used to, among other things, generate “send” and “end” signals. One such keypad 100 is shown in FIG. 1. The keypad 100 includes a “send” key 101 and an “end” key 102 thereon. The nomenclature on the keys may differ from “send” and “end”, however the functionality to the user remains the same. Other examples for “send” and “end” are “yes” or “talk” (for send) and “no” (for end).

Once a telephone number is “dialed” (i.e., essentially entered into memory of the wireless telephone for recovery and transmission at a later point in time, that is, when the “send” button is depressed), a wireless telephone user presses the “send” key 101 and the wireless telephone, utilizing the technology which supports the voice transmission of that particular wireless telephone set (e.g., GSM, CDMA, TDMA, FDMA, etc.) transmits information to the MSC (Mobile Switching Center), which informs the MSC that there is a wireless telephone unit which needs to be connected to another telephone number using the functionality and features of the MSC. Therein, the MSC recognizes the wireless mobile as a subscriber or a roamer and either allows or disallows the call based upon a number of criteria, some of which include proper authority to use the system, types of calls permitted to be made by that wireless unit or if the subscriber's account is current. Once the MSC has authorized the wireless unit to proceed with the process of establishing the connection through the MSC, the wireless unit (once again using the technology standard employed) in essence transmits the dialed telephone number or data that will permit the MSC to emulate the process of “dialing” a number to a wireless network (not shown), which establishes proper communication with the dialed telephone number. When the user desires to end the call, the “end” key 102 is depressed and the call is terminated.

As costs associated with providing wireless services decrease, wireless services are becoming competitive with traditional wireline services. As a part of this trend, wireless systems have been developed which may be installed in homes and offices akin to home-based wireline systems. More specifically, referring to FIG. 2, a plurality of telephones 200 may be connected to one another within the home or office 300 via standard home telephone wiring 400. A subscriber line interface circuit (SLIC) 500 connects to the standard home or office wiring 400, and provides a connection to a wireless communications network 600 via wireless transceiver 700 and an antenna 750. The SLIC 500 acts as an interface between the telephones 200, the wireless transceiver 700 and the wireless network 600, providing all of the electronics for dialing and transmitting the call via the transceiver 700 to the antenna 750. This configuration is known in the industry as a wireless local loop (WLL) system 800. When placing a call using a WLL system 800, any of the plurality of telephones 200 may be picked up and dialed. The SLIC 500 monitors each telephone 200 via the on-premise wiring, and when a telephone is picked up (goes “off-hook”), the SLIC 500 monitors the on-premise wiring connected to the telephone 200 for DTMF tones that are dialed from any of the telephones that are connected to the wiring and that are “monitored” by the SLIC 500. The SLIC 500 recognizes each number tone, converts the tone into a coded number equivalent which can be replicated at a later time, and then places the coded numbers into memory (as in the use of last number dialed memory currently employed in wireline telephones).

Once the user has completed dialing, a signal is needed to notify the SLIC 500 that the call is ready to be placed. One method is to have a telephone 200 which has a specialized keypad with “send” and “end” keys similar to the same keys on the wireless telephone of FIG. 1. At this point, the “send” key is depressed and the SLIC 500 makes a connection via the wireless network 600. When the SLIC 500 receives acknowledgment of the equivalent of call supervision from the wireless network, it then transmits the dialed number, and keeps the connection established until it is signaled to terminate the call. When the user desires to terminate the call, the “end” key is depressed, at which point the SLIC 500 terminates the connection with the wireless network 600.

Because most standard telephones, as shown in FIG. 3, that are currently in use do not have “send” or “end” keys, an alternate way of initiating the send and end signals is desirable. This would allow the use of standard consumer-available (e.g., off-the-shelf”) telephones, avoiding the necessity and cost of purchasing specialized telephones for use with WLL systems.

Others in the industry have proposed alternative ways of initiating send signals, thereby eliminating the need for specialized telephones. One such way is by programming an interface device which could be located at the same point as the SLIC 500 (or alternatively at the handset) to recognize the digits dialed, doing an analysis on the dialed digits, and then generating a send signal once a predetermined number of digits have been dialed. For example, if the interface device identified a “1” as the first digit dialed, it would identify the call as domestic long distance and wait for the user to dial ten more digits, automatically generating a send signal upon the entry of the tenth digit. The interface device would also recognize other common prefixes and numbers and generate a send signal based upon the number of digits dialed.

This method of generating a send signal was developed with the anticipation of the MSC being incapable of doing any analysis of the numbers dialed and was developed without the anticipation of the mobile units having enough memory to hold the dialed digits in memory and sending them upon the automatic connection interface between the wireless unit and the MSC via the wireless network. In addition to being generally obsolete because of routine technological advances in the industry, this method of generating a send signal has several disadvantages. One such disadvantage is that many international calls have different amounts of digits that have to be dialed, and therefore the interface device may generate erroneous send signals, resulting in the user being billed for spurious airtime and creating unnecessary network traffic. Additionally, if the dialed number has a number sequence that would indicate to the interface that the number has fewer digits than the interface device expects, it might not generate a send signal at all, potentially leaving the user unable to place the call. Also, with the increasing domestic use of ten digit dialing for local calls, an interface device using this method to generate send signals will become complicated to program, install, and maintain, as it would need to be customized during each installation to comply with the local dialing requirements. For example, in certain telephone exchanges or areas, ten digits are required for the completion of a local call, while in other areas only seven digits are required. Furthermore, it is not uncommon for local dialing areas to have local dialing requirements mixed between seven and ten digits. Accordingly, the aforementioned method of generating a send signal would also have to be reprogrammed every time any dialing requirements changed.

Another alternative for generating the send signal is to wait for a significant pause in dialing (i.e., wait a predetermined period of time since the last digit was dialed before generating a send signal). When a pause of a predetermined length is detected, the interface device automatically generates a send signal. This method has the disadvantage of generating a false send signal anytime a sufficiently long pause in dialing occurs, regardless of whether the user had entered the complete number or not. Again, this may result in a user being billed for spurious airtime (or, if the network carrier does not charge for airtime until a connection is made through the MSC, the MSC would be “tied up” for countless minutes of non-revenue producing and nuisance time). Another disadvantage is that the user will always have to wait for the length of the pause period before a call is placed after completion of dialing. The cumulative effect of all of these pauses can add up to a large amount of wait time, which the user may find annoying.

In addition to using a standard telephone with the aforementioned “send” signal generating techniques, some in the industry have also attempted to make a WLL system seem more like a standard wireline system by having the SLIC 500 automatically generate a dial tone when it detects an off-hook condition. Thus, when a user picks up a telephone 200 associated with a WLL system 800, the user hears the same or nearly the same dial tone as heard with a standard wireline phone coming off-hook and being connected to a conventional wireline telephone network, and the user may be unaware that the call is being placed via a wireless system. As pricing differences currently exist between wireless systems and traditional wireline systems, it would be useful for the user to have knowledge, or even be alerted, that he/she is using a wireless system. For example, with traditional wireline systems, users are generally not charged for local calls beyond the basic periodic flat rate service cost of the line, whereas many wireless systems may impose incremental charges for local calls. In addition, in the case of incoming calls, standard wireline users are not charged for such calls, whereas wireless users generally are charged. Thus, if a user knew he/she was using a wireless system, among other things, he/she may choose to keep calls shorter, or not make less important calls, in order to keep costs to a minimum.

Accordingly, there is a need for a system and method that overcomes all of the problems described above.

### SUMMARY OF THE INVENTION

The present invention is designed to overcome the aforementioned problems and meet the above-described needs.

The present invention provides a method and apparatus for placing and receiving telephone calls via a wireless communications network using a standard telephone and, therefore, is referred to as a wireless local loop system that uses a standard telephone. More specifically, in one embodiment, the “*” key is advantageously used to generate a send signal, while the “#” key is advantageously used to generate an end signal. Accordingly, automatic generation of false send signals may be eliminated, while the need of purchasing and installing a specialized telephone handset having a send key and end key thereon may be avoided.

Furthermore, in one embodiment, when placing a call, a recorded message (instead of a dial tone) is advantageously played to a user when a telephone is taken “off-hook” so that a user may be notified that the call will be transmitted via a wireless network and, therefore, may be subject to a different pricing structure. In addition, upon receipt of an incoming call, a similar recorded message may be played to a user for like purposes.

Even further, in one embodiment, the wireless local loop may include a voice storage chip for storing a variety of recorded messages that are, preferably, communicated to the voice storage chip via a wireless communications network. Accordingly, the above-described recorded messages may be varied, for example, for advertising purposes or to provide other useful information (e.g., emergencies, weather, traffic conditions, etc.), in addition to providing notification that the call will be made or is being received via a wireless network.

Additionally, in one embodiment, the wireless local loop system is integrated with a traditional wireline telephone system to create a mixed wireline/wireless system. In this embodiment, calls can be advantageously placed via either the wireless system or the wireline system, depending upon which is currently available or which the user wished to access for the call.

### BRIEF DESCRIPTION OF THE DRAWINGS

FIG. 1 is a diagrammatic representation of one type of conventional wireless telephone, illustrating its keypad;

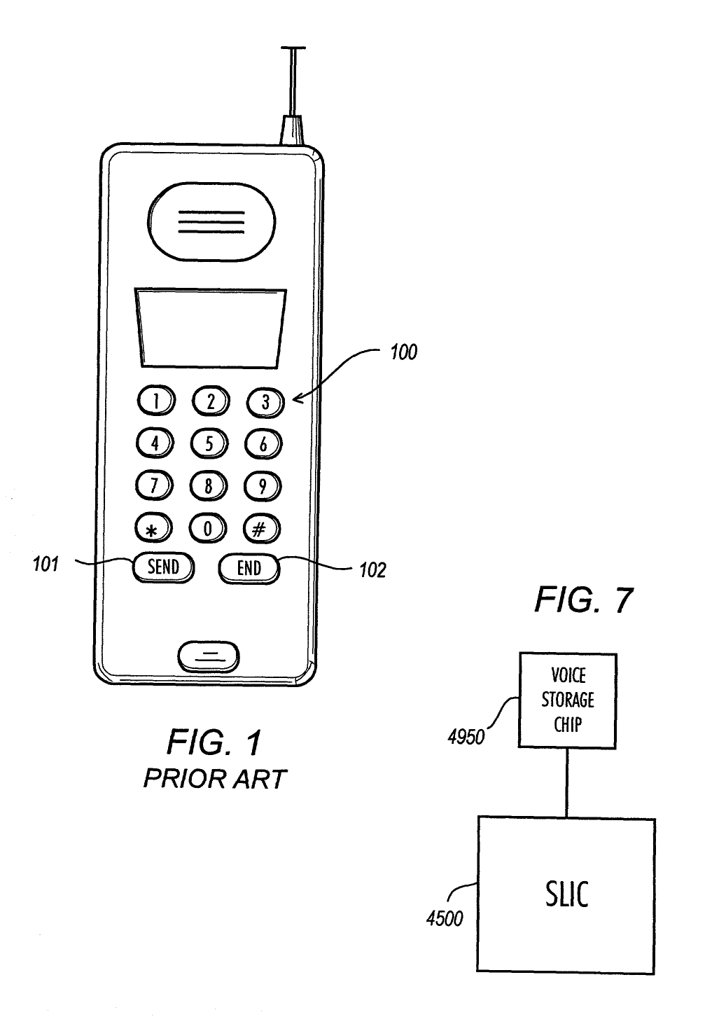

FIG. 2 is a diagrammatic representation of a conventional wireless local loop system;

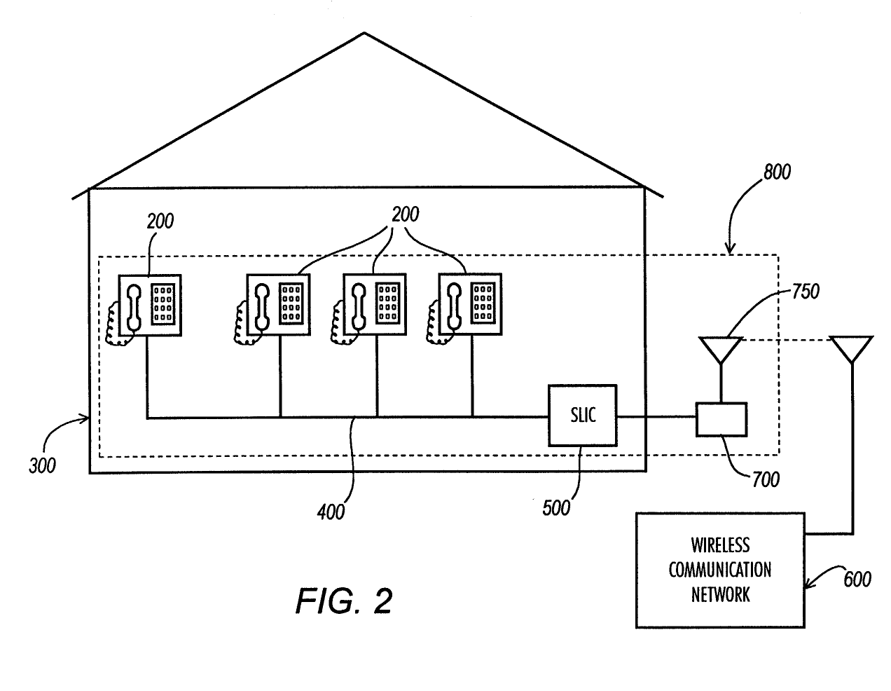

FIG. 3 is a diagrammatic representation of a standard telephone showing a standard keypad, which is used in connection with the present invention;

FIG. 4 is a diagrammatic representation of a wireless local loop system of the present invention;

FIG. 5 is a diagrammatic representation of a mixed wireline/wireless system;

FIG. 6 is a diagrammatic representation of a mixed wireline/wireless system showing a dedicated line configuration, which is used in connection with the present invention; and, FIG. 7 is a diagrammatic representation of a SLIC having an associated voice storage chip.

### DETAILED DESCRIPTION OF THE PREFERRED EMBODIMENT

While this invention is susceptible of embodiments in many different forms, there is shown in the drawings and will herein be described in detail, preferred embodiments of the invention with the understanding that the present disclosure is to be considered as an exemplification of the principles of the invention and is not intended to limit the broad aspects of the invention to the embodiments illustrated.

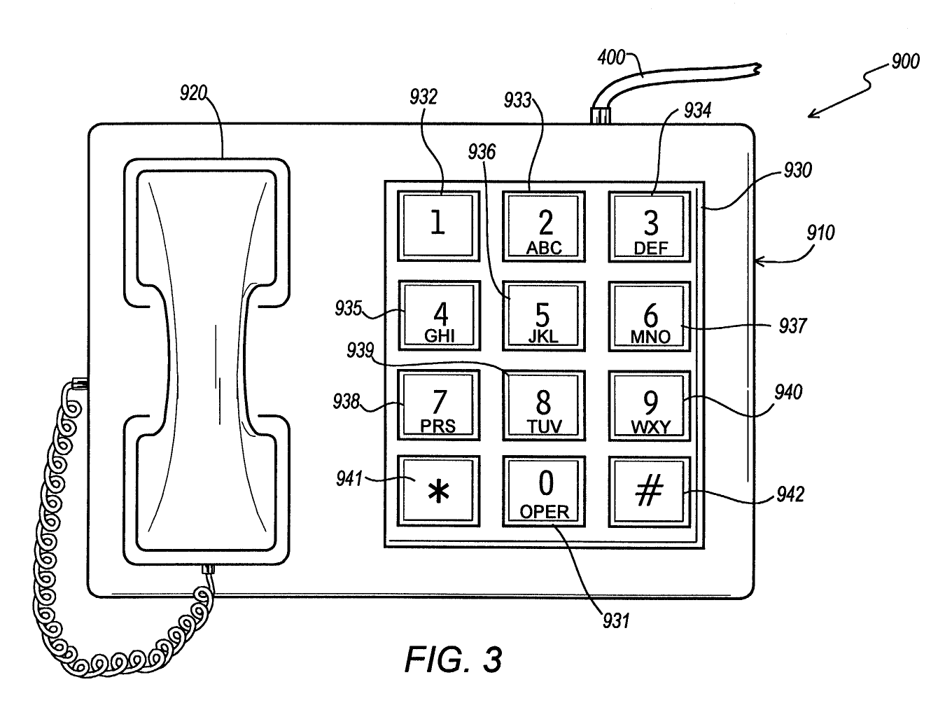

A telephone, generally designated 900, is illustrated in FIG. 3. The telephone 900 includes a telephone base 910, a handset 920 and a keypad 930. The keypad 930 includes the keys normally found on a standard telephone keypad, namely, number keys 0-9 (identified by reference numerals 931-940, respectively), the “*” key 941 and “#” key 942.

For purposes of the present invention, the term standard telephone includes telephones that are in compliance with FCC Part 68 or telephones that meet the respective registration criteria of other countries. More specifically, a standard telephone could include a registration number as set forth in FCC docket 19528, Part 68; the presence of which (on the telephone) indicates that the FCC has approved the telephone as being a compatible device for direct connection to telephone line facilities.

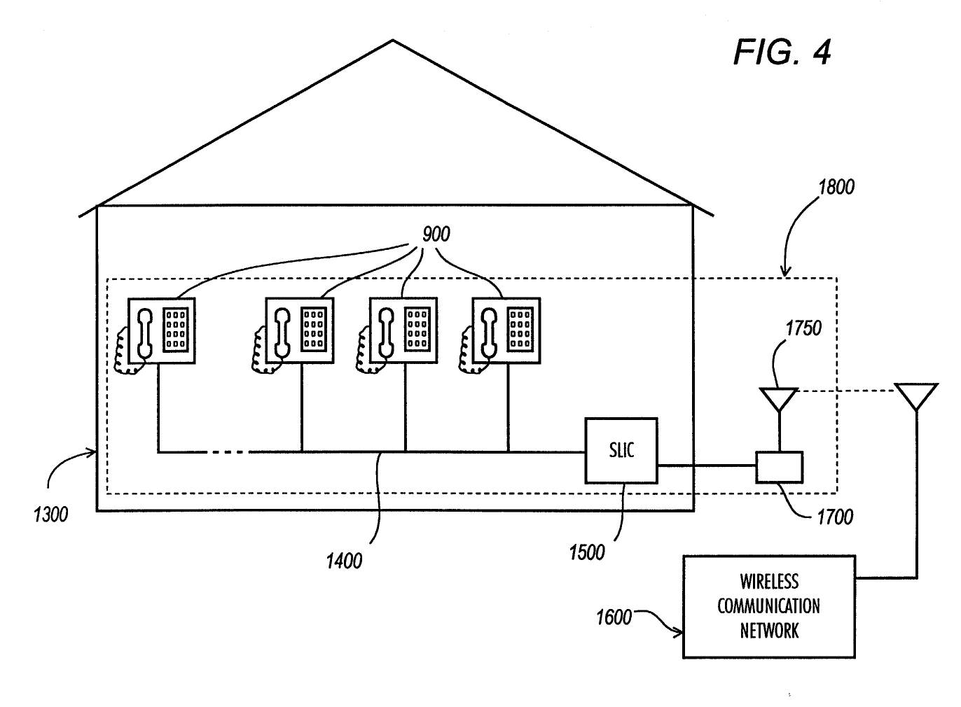

As shown in FIG. 4, a plurality of telephones (with standard keypads) 900 are connected to each other within a home or office via standard home telephone wiring 1400. A subscriber line interface circuit (SLIC) 1500, which is connected to the standard home telephone wiring 1400, provides an interface to a transceiver 1700 and antenna 1750 to form a connection with a wireless communications system 1600. The SLIC 1500 provides the wireless communication link between the telephones 900 in the home or office 1300, and the wireless communication network 1600. One example of a SLIC is the Am79R79 Ringing Subscriber Line Interface Circuit manufactured by Advanced Micro Devices, Inc., Sunnyvale, Calif.

Reference is now made to FIGS. 3 and 4, which will be used to describe a preferred embodiment of the invention. When a user wishes to place a call, the user lifts handset 920 from the telephone base 910. In turn, the SLIC 1500 detects an off-hook condition, and generates a recorded message which notifies the user that he/she is using a wireless system. Further, the SLIC 1500 provides the user with instructions on both the dialing procedure and the procedure for terminating a call. In a preferred embodiment, the recorded message states “Welcome to XYZ Wireless. Please dial the number you wish to call, then press the star (*) key. Press the pound (#) key to end your call or simply hang up.” (As will be understood by those skilled in the art, the message may take on a variety of appropriate forms.) The SLIC 1500 is programmed to understand that the “*” key 941 is used to request the SLIC to generate a send signal and the “#” key 942 is used to request the SLIC to generate an end signal (more correctly, a technology-specific end signal).

Once a user becomes familiar with the system, he/she may not want to listen to the complete message. Thus, once the SLIC 1500 recognizes that any key has been depressed, the voice-synthesized message will stop. Once dialing begins, the SLIC 1500 stores the dialed digits in memory and depression of the “*” key 941 signals the SLIC 1500 to make a connection to the wireless network 1600 via the transceiver 1700 and antenna 1750.

When the call is completed, the user can depress the “#” key 942, and the SLIC 1500 will generate an end signal and terminate the connection to the wireless network 1600. In the preferred embodiment, the SLIC 1500 may also automatically generate an end signal upon detection of an on-hook condition, which gives the user the option of just hanging up the handset 920 when the call is complete.

Because many automated telephone applications require depression of the “#” key 942 to perform certain functions, one embodiment of the present invention requires the user to depress the “*” key 941 two times in order for the SLIC 1500 to generate a send signal and the “*” key 941 followed by the “#” key 942 in order the SLIC 1500 to generate an end signal. For example, many voice mail systems ask for a password to be entered, followed by the “#” key 942. The present embodiment would prevent the SLIC 1500 from inadvertently ending the call upon the depression of the “#” key 942. With respect to the generation of an end signal, once a connection is established and a call is placed, the SLIC 1500 would monitor the line for the depression of the “*” key 941. Upon detection of this event, the SLIC 1500 would start a timer and monitor for the depression of the “#” key 942. If the “#” key 942 is depressed within 3 seconds, for example, of the “*” key 941, the SLIC 1500 would be programmed to generate the end signal and terminate the call. If the time period lapses, or there is a depression of a key other than the “#” key 942, the SLIC 1500 again monitors for the depression of the “*” key 941. A similar timer technique could be used in connection with generating a send signal, as will be understood by those skilled in the art.

When an incoming call is to be received via the wireless local loop 1800, the SLIC 1500 detects the presence of the call and causes the plurality of telephones 900 in the wireless local loop 1800 to ring. When one of the telephones 900 comes off-hook, the SLIC 1500 makes a connection. In one embodiment, when the telephone 900 comes off-hook, the SLIC 1500 will optionally playback a recorded message notifying both parties that the call is being carried by a wireless carrier and may be subject to a different rate than a wireline connection. For example, the recorded message might state “This call is being carried by XYZ Wireless.” Optionally, the recorded message could be played only in the earpiece of the called party. When the user wants to end the call, he/she uses one of call-termination procedures described above.

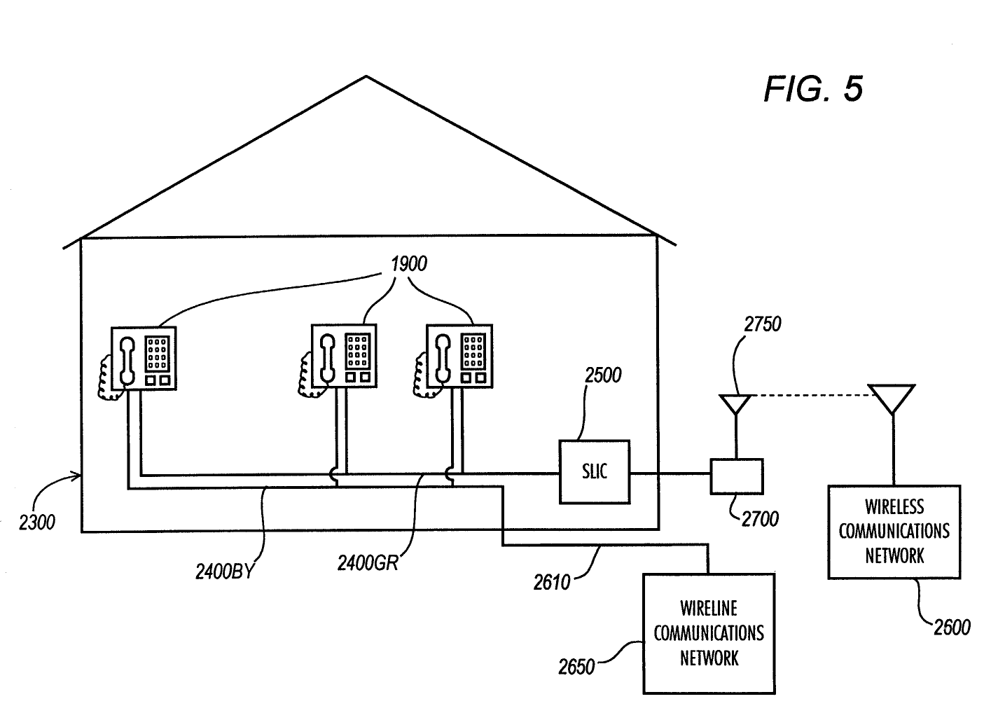

In another embodiment, shown in FIG. 5, the present invention is used in a mixed wireless/wireline environment. This embodiment requires the use of a standard two-line telephone 1900, which is used to switch between the two lines of telephone wiring commonly installed in a home (i.e., the green/red pair and black/yellow pair). For illustrative purposes, the green/red pair is identified by reference numeral 2400GR and the black/yellow pair is identified by reference numeral 2400BY.

As shown in FIG. 5, each two-line telephone 1900 may be connected to both the green/red pair 2400GR (e.g., line 1) and the black/yellow pair 2400BY (e.g., line 2). The green/red pair 2400GR is connected to SLIC 2500, which provides an interface to a transceiver 2700 and an antenna 2750 to form a connection with a wireless communications system 2600, in a manner similar to that described in connection with FIG. 4. The black/yellow pair 2400BY is connected to wireline communications network 2650 via wireline connection 2610.

In the configuration shown in FIG. 5, a user may select between a wireless network or a wireline network in placing a telephone call. This is accomplished merely by depressing the button (e.g., “line 1” or “line 2” button) on the two-line telephone 1900 associated with the appropriate network. If the button associated with the wireless network was depressed, the telephone would function like the device shown in FIG. 4. If, on the other hand, the button associated with the wireline network was depressed, the telephone would operate like a normal wireline telephone.

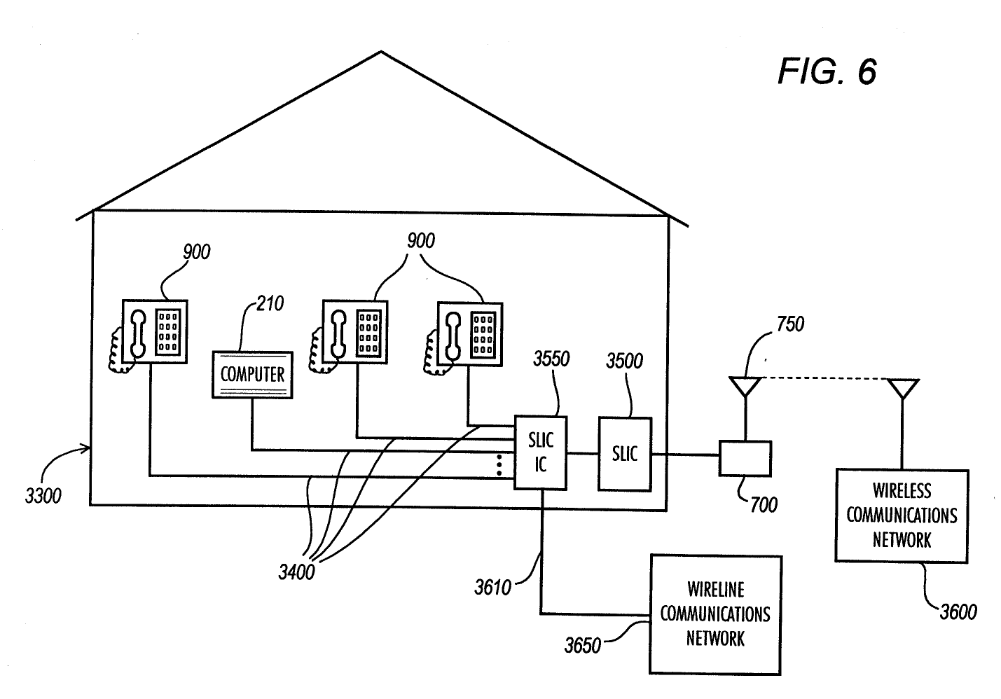

In another embodiment, as shown in FIG. 6, standard in-home wiring 3400 is routed to the SLIC interface circuit 3550 in a hub and spoke type configuration, allowing both standard single-line telephones and the ability to place concurrent wireless and wireline calls. This would allow each individual telephone to have a dedicated connection to the SLIC interface circuit 3550, since (in this embodiment) the SLIC interface circuit 3550 would have a sensor and a switch. When the sensor detected that a call was placed over either one of the networks, it would activated the switch such that if any other telephone came off-hook, it would automatically be routed to the available network. Thus in this embodiment, the user is not required to purchase more expensive dual-line telephones, and is still able, for example, to place calls via the wireless network 3600 when the wireline network is in use and be notified of the network which is being used for the call.

In yet another embodiment, a SLIC 4500 or a SLIC interface circuit 4550 (see FIG. 7) could have an associated voice storage chip 4950, which could be pan of the SLIC 4500 (or an entirely separate device). The voice storage chip 4950 would be used to store messages transmitted from a wireless communications network or a wireline communications network, wherein such messages would be used instead of a dial tone, as described above. Advantageously, the voice storage chip 4950 would allow the stored messages to be varied. In addition, different households or businesses could receive different messages from the wireline or wireless communication networks based upon a variety of different criteria (e.g., age, purchasing patterns, geographic location, time of day, etc.)

For example, households or businesses in a first subdivision might receive a message which would advertise a sale at a particular store in a neighborhood, while households or businesses in a second subdivision might receive a message which would advertise a sale at a different store in a different neighborhood. The messages could include, for example, emergency advisements, advertisements, weather reports, traffic conditions, public-service announcements and other items of information. Essentially, the type of information included in the messages is limitless. Generally, dialing instructions (discussed above) would follow the advertising portion (for example) of the message. In one embodiment, the SLIC might be programmed to prevent dialing until the advertising portion (or other portion) of the message had been completed.

It should be understood that many options exist with respect to structure of the present invention. For example, the roles of the “*” key 941 and the “#” key 942 may be reversed. Additionally, only one of the “*” key 941 or “#” key 942 may be used to generate the send and end signals. Specifically, the SLIC 1500 may be programmed to recognize that, when a connection is made to a wireless network 1600, a send signal is to be generated upon depression of the “#” key 942 (or “*” key 941). Likewise, the SLIC 1500 may be programmed to recognize that, when a connection is made to the wireless network 1600, an end signal is to be generated upon depression of the “#” key 942, or upon a sequence of keys. In such case, the “*” key 941 (or “#” key 942) may be freed to perform other special functions.

As mentioned above, because many automated telephone applications require depression of either the “*” or “#” keys to perform certain functions, in another embodiment of the present invention, the “#” and “*” keys may be ignored by the SLIC once a send signal has been generated. (The send signal could be generated by pressing the “#” key twice, for example.) In such case, an end signal would be generated upon detection of an on-hook condition. Thus, advantageously, the present invention could be used effectively with automated telephone applications.

As will be understood by those skilled in the art, the recorded messages may take on a variety of forms. For example, they may include digitally-recorded messages, analog-recorded messages, voice-synthesized messages, etc.

It should be understood that a telephone need not include both a base and a handset for purposes of going “off-hook” and being “on-hook.” Specifically, a telephone may go “off-hook” or be placed “on-hook” by depression of a button or switch. For example, standard telephones with “speakerphone” features are commonly switched from their “off-hook” and “on-hook” positions by depression of a button. Similarly, standard telephones which are “cordless” likewise can optionally be switched from their “off-hook” and “on-hook” positions by depression of a button.

In addition, the present invention may be extended to rotary dial telephones, as will be understood by those skilled in the art.

It will be understood that the invention may be embodied in other specific forms without departing from the spirit or central characteristics thereof. The present examples and embodiments, therefore, are to be considered in all respects as illustrative and not restrictive, and the invention is not intended to be limited to the details given herein.

What is claimed is:

1. A wireless communications system comprising:
a base transceiver system for receiving and transmitting signals;
a telephone with a standard keypad with keys for dialing, the standard keypad having at least a “*” key, a “#” key and number keys 0-9; and,
a subscriber line interface circuit having a transceiver and antenna system associated therewith, wherein the subscriber line interface circuit couples the telephone to the transceiver and antenna system and wherein the transceiver and antenna system couples the telephone wirelessly to the base transceiver system, the subscriber line interface circuit being coupled to the telephone via one or more conductors, having a memory unit for storing information relating to dialed keys and having a processing unit for recognizing the information,
wherein the subscriber line interface circuit initiates a wireless connection via the transceiver and antenna system to the base transceiver system after the processing unit recognizes that the “*” key has been depressed.

2. The wireless communications system of claim 1, wherein the subscriber line interface circuit terminates the wireless connection via the transceiver and antenna to the base transceiver system after the processing unit recognizes that the “#” key has been depressed.

3. The wireless communications system of claim 1, wherein the subscriber line interface circuit includes a timing circuit programmed with a time period,
wherein the subscriber line interface circuit starts the timing circuit after the processing unit recognizes that the “#” key has been depressed,
wherein the subscriber line interface circuit terminates the timing circuit after the processing unit recognizes that a key other than the “#” key has been depressed prior to the expiration of the time period,
wherein the subscriber line interface circuit terminates the wireless connection to the base transceiver system after the processing unit recognizes that the “#” key has been depressed prior to the expiration of the time period.

4. The wireless communications system of claim 1, wherein the processing unit is programmed to monitor the telephone to sense when it comes off-hook and to generate a recorded message.

5. The wireless communications system of claim 4, wherein the subscriber line interface circuit is programmed to discontinue the recorded message upon detection of a key being depressed.

6. The wireless communications system of claim 1, wherein the processing unit of the subscriber line interface circuit is programmed to both monitor the telephone to sense when it comes off-hook and monitor for incoming calls, wherein the processing unit, when an incoming call is detected, causes a ringing pulse to be generated and sent thereby causing the telephone to ring.

7. The wireless communications system of claim 6, wherein the processing unit via the transceiver and antenna system establishes a wireless connection to the base transceiver system upon sensing an off-hook condition.

8. The wireless communications system of claim 7, wherein the subscriber line interface circuit generates a recorded message upon sensing an off-hook condition to notify a user that the incoming call is being carried via a wireless service provider.

9. The wireless communications system of claim 1, wherein the subscriber line interface circuit is programmed to automatically terminate the connection with the wireless communications network upon the detection of the telephone going on-hook.

10. The wireless communications system of claim 1, wherein the subscriber line interface circuit terminates the wireless connection to the base transceiver system upon depression of the “*” key.

11. The wireless communications system of claim 1, wherein the subscriber line interface circuit includes a timing circuit programmed with a time period,
wherein the subscriber line interface circuit starts the timing circuit after the processing unit recognizes that the “*” key has been depressed,
wherein the subscriber line interface circuit terminates timing circuit after the processing unit recognizes that a key other than the “*” key has been depressed prior to the expiration of the time period,
wherein the subscriber line interface circuit terminates the wireless connection to the base transceiver system after the processing unit recognizes that the “*” key has been depressed prior to the expiration of the time period.

12. A wireless communications system comprising:
a base transceiver system for receiving and transmitting signals;
a telephone with a standard keypad with keys for dialing, the standard keypad having at least a “*” key, a “#” key and number keys 0-9; and,
a subscriber line interface circuit having a transceiver and antenna system associated therewith, wherein the subscriber line interface circuit couples the telephone to the transceiver and antenna system and wherein the transceiver and antenna system couples the telephone wirelessly to the base transceiver system, the subscriber line interface circuit being coupled to the telephone via one or more conductors, having a memory unit for storing information relating to dialed keys and having a processing unit for recognizing the information,
wherein the subscriber line interface circuit initiates a wireless connection via the transceiver and antenna system to the base transceiver system after the processing unit recognizes that the “#” key has been depressed.

13. The wireless communications system of claim 12, wherein the subscriber line interface circuit terminates the wireless connection via the transceiver and antenna to the base transceiver system after the processing unit recognizes that the “*” key has been depressed.

14. The wireless communications system of claim 12, wherein the processing unit is programmed to monitor the telephone to sense when the telephone comes off-hook and to generate a recorded message.

15. The wireless communications system of claim 14, wherein the subscriber line interface circuit is programmed to discontinue the recorded message upon detection of a key being depressed.

16. The wireless communications system of claim 12, wherein the processing unit of the subscriber line interface circuit is programmed to both monitor the telephone to sense when the telephone comes off-hook and monitor for incoming calls, wherein the processing unit, when an incoming call is detected, causes a ringing pulse to be generated and sent thereby causing the telephone to ring.

17. The wireless communications system of claim 16, wherein the processing unit via the transceiver and antenna system establishes a wireless connection to the base transceiver system upon sensing an off-hook condition.

18. The wireless communications system of claim 17, wherein the subscriber line interface circuit generates a recorded message upon sensing an off-hook condition to notify a user that the incoming call is being carried via a wireless service provider.

19. The wireless communications system of claim 12, wherein the subscriber line interface circuit is programmed to automatically terminate the connection with the wireless communications network upon the detection of the telephone going on-hook.

20. The wireless communications system of claim 12, wherein the subscriber line interface circuit terminates the wireless connection to the base transceiver system upon depression of the “#” key.

21. A method for using a telephone having a standard keypad with a wireless communications network, wherein the keypad includes a “*” key, a “#” key and number keys 0-9, the method comprising the steps of:
providing a subscriber line interface circuit having a transceiver and antenna system associated therewith, the subscriber line interface circuit coupling the standard telephone to the transceiver and antenna system;
monitoring the telephone for dialed numbers using the subscriber line interface circuit;
storing the dialed numbers in a memory, wherein the memory is associated with the subscriber line interface circuit;
monitoring the telephone, via the subscriber line interface circuit, for the depression of the “#” key; and,
initiating a wireless connection from the transceiver and antenna system to the wireless communications network upon the depression of the “*” key using the subscriber line interface circuit.

22. The method of claim 21 including the step of monitoring the telephone for an off-hook condition using the subscriber line interface circuit.

23. The method of claim 22 including the step of generating a message, using the subscriber line interface circuit, to provide dialing instructions to a user upon detection of the off-hook condition.

24. The method of claim 21 including the steps of:
monitoring the telephone, via the subscriber line interface circuit, for the depression of the “#” key; and,
terminating the connection to the wireless communications network, using the subscriber line interface circuit, upon the depression of the “#” key.

25. The method of claim 21 including the steps of:
monitoring the telephone, via the subscriber line interface circuit, for the depression of the “#” key;
starting a timer and monitoring the telephone, via the subscriber line interface circuit, for the depression of another key within a predetermined time period; and,
terminating the connection to the wireless communications network, using the subscriber line interface circuit, upon the depression of the “#” key within the predetermined time period.

26. The method as claimed in claim 24, wherein after the message is generated, monitoring the telephone for the depression of a key using the subscriber line interface circuit and terminating the voice synthesized message after a key has been depressed.

27. A method for using a telephone having a standard keypad with a wireless communications network, wherein the keypad includes a “*” key, a “#” key and number keys 0-9, the method comprising the steps of:
providing a subscriber line interface circuit having a transceiver and antenna system associated therewith, the subscriber line interface circuit coupling the telephone to the transceiver and antenna system;
monitoring the telephone for dialed numbers using the subscriber line interface circuit;
storing the dialed numbers in a memory, wherein the memory is associated with the subscriber line interface circuit;
monitoring the telephone, via the subscriber line interface circuit, for the depression of the “#” key; and,
initiating a connection from the transceiver and antenna system to the wireless communications network upon the depression of the “#” key using the subscriber line interface circuit.

28. The method of claim 27 including the step of monitoring the telephone for an off-hook condition using the subscriber line interface circuit.

29. The method of claim 28 including the step of generating a message, using the subscriber line interface circuit, to provide dialing instructions to a user upon detection of the off-hook condition.

30. The method of claim 27 including the steps of:
monitoring the telephone, via the subscriber line interface circuit, for the depression of the “#” key; and,
starting a timer and monitoring the telephone, via the subscriber line interface circuit, for the depression of another key within a certain time period; and,
terminating the connection to the wireless communications network, using the subscriber line interface circuit, upon the depression of the “#” key within the time period.

31. The method as claimed in claim 29, wherein after the message is generated, monitoring the telephone for the depression of a key using the subscriber line interface circuit and terminating the message after a key has been depressed.

32. A mixed wireless/wireline communications system comprising:
a base transceiver system for receiving and transmitting calls via a wireless network;
a wireline for receiving and transmitting calls via a wireline network;
a two-line telephone with a standard keypad with keys for dialing, the standard keypad having at least a “*” key and a “#” key and number keys 0-9, the wireline being connected to a first line of the two-line telephone;
a subscriber line interface circuit having a transceiver and antenna system associated therewith, wherein the subscriber line interface circuit couples a second line of the two-line telephone to the transceiver and antenna system and wherein the transceiver and antenna system couples the second line of the two-line telephone wirelessly to the base transceiver system, the subscriber line interface circuit having a memory unit for storing information relating to keys dialed when the second line of the two-line telephone is active and a processing unit for recognizing the information,
wherein the subscriber line interface circuit interface initiates a wireless connection via the transceiver and antenna system to the base transceiver system after the processing unit recognizes that the “*” key has been depressed.

33. The mixed wireless/wireline communications system of claim 32, wherein the subscriber line interface circuit terminates the wireless connection to the base transceiver system after the processing unit recognizes that the “#” key has been depressed.

34. The mixed wireless/wireline communications system of claim 32, wherein the subscriber line interface circuit includes a timing circuit programmed with a predetermined time period,
wherein the subscriber line interface circuit starts the timing circuit after the processing unit recognizes that the “#” key has been depressed,
wherein the subscriber line interface circuit terminates timing circuit after the processing unit recognizes that a key other than the “#” key has been depressed prior to the expiration of the predetermined time period,
wherein the subscriber line interface circuit terminates the wireless connection to the base transceiver system after the processing unit recognizes that the “#” key has been depressed prior to the expiration of the predetermined time period.

35. The mixed wireless/wireline communications system of claim 32, wherein the processing unit of the subscriber line interface circuit interface is programmed to monitor the telephone to sense when the telephone comes off-hook and to generate a message.

36. The mixed wireless/wireline communications system of claim 35, wherein the subscriber line interface circuit interface is programmed to discontinue the message upon detection of a key being depressed.

37. The mixed wireless/wireline communications system of claim 32, wherein the processing unit of the subscriber line interface circuit is programmed to monitor for incoming calls, wherein the processing unit, when an incoming call is detected, causes a ringing pulse to be generated and sent thereby causing the telephone to ring.

38. The mixed wireless/wireline communications system of claim 37, wherein the processing unit establishes a connection to the base transceiver system upon sensing an off-hook condition.

39. The mixed wireless/wireline communications system of claim 38, wherein the subscriber line interface circuit generates a message upon sensing an off-hook condition to notify a user that the incoming call is being carried via a wireless service provider.

40. The mixed wireless/wireline communications system of claim 32, wherein the subscriber line interface circuit is programmed to automatically terminate the connection with the wireless communications network upon the detection of the telephone going on-hook.

41. The mixed wireless/wireline communications system of claim 32, wherein the subscriber line interface circuit terminates the wireless connection to the base transceiver system upon depression of the “*” key.

42. The mixed wireless/wireline communications system of claim 32, wherein the subscriber line interface circuit includes a timing circuit programmed with a predetermined time period,
wherein the subscriber line interface circuit starts the timing circuit after the processing unit recognizes that the “*” key has been depressed,
wherein the subscriber line interface circuit terminates timing circuit after the processing unit recognizes that a key other than the “*” key has been depressed prior to the expiration of the predetermined time period,
wherein the subscriber line interface circuit terminates the wireless connection to the base transceiver system after the processing unit recognizes that the “*” key has been depressed prior to the expiration of the predetermined time period.

43. A mixed wireless/wireline communications system comprising:
a base transceiver system for receiving and transmitting calls via a wireless network;
a wireline for receiving and transmitting calls via a wireline network;
a two-line telephone with a standard keypad with keys for dialing, the standard keypad having at least a “*” key and a “#” key and number keys 0-9, the wireline being connected to a first line of the two-line telephone;
a subscriber line interface circuit having a transceiver and antenna system associated therewith, wherein the subscriber line interface circuit couples a second line of the two-line telephone to the transceiver and antenna system and wherein the transceiver and antenna system couples the second line of the two-line telephone wirelessly to the base transceiver system, the subscriber line interface circuit having a memory unit for storing information relating to keys dialed when the second line of the two-line telephone is active and a processing unit for recognizing the information,
wherein the subscriber line interface circuit interface initiates a wireless connection via the transceiver and antenna system to the base transceiver system after the processing unit recognizes that the “#” key has been depressed.

44. The mixed wireless/wireline communications system of claim 43, wherein the subscriber line interface circuit terminates the wireless connection to the base transceiver system after the processing unit recognizes that the “#” key has been depressed.

45. The mixed wireless/wireline communications system of claim 43, wherein the subscriber line interface circuit includes a timing circuit programmed with a predetermined time period,
wherein the subscriber line interface circuit starts the timing circuit after the processing unit recognizes that the “#” key has been depressed,
wherein the subscriber line interface circuit terminates timing circuit after the processing unit recognizes that a key other than the “#” key has been depressed prior to the expiration of the predetermined time period,
wherein the subscriber line interface circuit terminates the wireless connection to the base transceiver system after the processing unit recognizes that the “#” key has been depressed prior to the expiration of the predetermined time period.

46. The mixed wireless/wireline communications system of claim 43, wherein the processing unit of the subscriber line interface circuit interface is programmed to monitor the telephone to sense when the telephone comes off-hook and to generate a message.

47. The mixed wireless/wireline communications system of claim 46, wherein the subscriber line interface circuit interface is programmed to discontinue the message upon detection of a key being depressed.

48. The mixed wireless/wireline communications system of claim 43, wherein the processing unit of the subscriber line interface circuit is programmed to monitor for incoming calls, wherein the processing unit, when an incoming call is detected, causes a ringing pulse to be generated and sent thereby causing the telephone to ring.

49. The mixed wireless/wireline communications system of claim 48, wherein the processing unit establishes a connection to the base transceiver system upon sensing an off-hook condition.

50. The mixed wireless/wireline communications system of claim 49, wherein the subscriber line interface circuit generates a message upon sensing an off-hook condition to notify a user that the incoming call is being carried via a wireless service provider.

51. The mixed wireless/wireline communications system of claim 43, wherein the subscriber line interface circuit is programmed to automatically terminate the connection with the wireless communications network upon the detection of the telephone going on-hook.

52. The mixed wireless/wireline communications system of claim 43, wherein the subscriber line interface circuit terminates the wireless connection to the base transceiver system upon depression of the “*” key.

53. The mixed wireless/wireline communications system of claim 43, wherein the subscriber line interface circuit includes a timing circuit programmed with a predetermined time period,
wherein the subscriber line interface circuit starts the timing circuit after the processing unit recognizes that the “*” key has been depressed,
wherein the subscriber line interface circuit terminates timing circuit after the processing unit recognizes that a key other than the “*” key has been depressed prior to the expiration of the predetermined time period,
wherein the subscriber line interface circuit terminates the wireless connection to the base transceiver system after the processing unit recognizes that the “*” key has been depressed prior to the expiration of the predetermined time period.
